(19) United States
(12) Patent Application Publication
(10) Pub. No.: US 2025/0368035 A1
(43) Pub. Date: Dec. 4, 2025

(54) INTEGRATED FUEL CELL POWER SPLIT VEHICLE SYSTEMS

(71) Applicant: Dana Heavy Vehicle Systems Group, LLC, Maumee, OH (US)

(72) Inventor: Jeffrey M. DAVID, Cedar Park, TX (US)

(21) Appl. No.: 18/679,086

(22) Filed: May 30, 2024

(51) Int. Cl. B60K 25/06; B60L 50/72; F16H 1/28; H01M 8/04111; H01M 8/10

(52) U.S. Cl. CPC B60K 25/06; B60L 50/72; H01M 8/04111; F16H 1/28; H01M 2008/1095; H01M 2250/20

(57) ABSTRACT

Systems and methods for operating a fuel cell electric vehicle are disclosed. In one example, a system is provided that comprises a fuel cell; a compressor; and an electric motor operationally coupled via a power split transmission to a driveshaft and the compressor. The power split transmission may be used to split input power from the electric motor into two power flows: one to the driveshaft or other traction device and the other to the compressor. In some examples, the power split transmission may comprise a planetary gearset.

### TECHNICAL FIELD

The present disclosure relates to fuel cell electric vehicle systems.

### BACKGROUND AND SUMMARY

Fuel cell electric vehicle systems use fuel cells to provide power to various system components. A hydrogen source may provide hydrogen to the fuel cell and an air compressor may be included to provide air to the fuel cell so that reactions between hydrogen and oxygen can take place at target ratios. Such systems may have two separate electric motor/inverter subsystems: one to operate the air compressor and the other to operate a driveshaft of a vehicle, for example.

The inventors herein have recognized inefficiencies in such systems with separate motor/inverter subsystems and have developed a system comprising a fuel cell, a compressor; and an electric motor operationally coupled via a power split transmission to a driveshaft and the compressor. The power split transmission may be used to split the input power into two power flows: one to the driveshaft or other traction device and the other to the compressor.

For example, the power split transmission may comprise planetary gearing to split the input power. The planetary gearing may comprise a sun gear, a carrier coupled to planet gears, and a ring gear; and the electric motor may be coupled to the carrier, the compressor may be coupled to the sun gear, and the driveshaft may be coupled to the ring gear. However, any suitable transmission system may be used to split the input power into two power flows: one to the driveshaft or traction device and the other to the compressor. The concept is generally extendable to any input split geartrain with or without downstream multispeed gearing arrangements.

By combining elements of the compressor and driveshaft/traction systems in this way, a reduction in complexity and cost of the system may be achieved since a single motor/inverter system is used to operate both the compressor and driveshaft/traction systems. Furthermore, such combined systems may enable load sharing capabilities and provides control opportunities for energy optimization in the system.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example fuel cell electric vehicle system in accordance with the disclosure.

FIG. 2 shows an example power split transmission configuration utilizing a simple planetary.

FIG. 3 shows an example method of operating a fuel cell electric vehicle system in accordance with the disclosure.

FIG. 4 shows an example power split transmission configuration utilizing a tapered traction drive planetary.

FIG. 5 shows an example power split configuration connected to a downstream gearbox.

FIG. 6 shows an example FCPS compressor power plot.

FIG. 7 shows an example FCPS tractive power output plot.

FIG. 8 shows an example FCPS compressor power ratio plot.

### DETAILED DESCRIPTION

Fuel cell electric systems are described herein that combine operation of an air compressor and traction devices, e.g., a driveshaft of a vehicle, and/or other devices in the system via a power split transmission. The power split transmission may be used to split input power from an electric motor powered by the fuel cell system into two power flows: one to the driveshaft or other device and the other to the compressor. As used herein the term “power split” is intended to mean any suitable system or component that takes a power input and outputs two or more power outputs, for example to two or more different subsystems. The term “transmission” as used herein is intended to mean any suitable system, component or medium that transmits power generated by a power source, e.g., a motor, to drive other components of a system. For example, if the fuel cell electric system comprises a fuel cell electric vehicle system, the transmission may comprise a mechanical system of gears or gear trains that transmits power generated by an electric motor to one or more wheels or traction devices in the vehicle system.

As mentioned above, fuel cell electric vehicle (FCEV) systems may use fuel cells to provide power to various system components. A hydrogen source may provide hydrogen to the fuel cell and an air compressor may be included to provide air to the fuel cell so that reactions between hydrogen and oxygen can take place in the fuel cell at target ratios.

Such systems may have two separate electric motor/inverter subsystems: one to operate the air compressor and the other to operate a driveshaft of a vehicle, for example. The inventors herein have recognized issues in such FCEV systems with separate motor/inverter subsystems. For example, such systems may have at least two standalone motor/inverter sub-systems, which can increase costs of the system and increase power consumption from the fuel cell and/or batteries in the system. In such systems the fuel cell air compressor may consume a large amount, e.g., up to 30%, of total power output of the battery or fuel cell with no mechanism to share fuel cell compression power load and traction load in the system. Further, such systems having a standalone motor and inverter for the compressor and traction system may constrain traction motor speed to vehicle road speed, thereby degrading efficiency and reducing opportunities for energy optimization.

In order to address these issues, the inventors herein have developed a system comprising a fuel cell, a compressor, and an electric motor operationally coupled via a power split transmission to a driveshaft or other device in the system and the compressor. The power split transmission may be used to split the input power into two power flows: one to the driveshaft or other device and the other to the compressor. In this way, operation of the air compressor and traction devices, e.g., a driveshaft of a vehicle, may be controlled to optimize energy consumption during different modes of operation of the system. Such a combined system may enable load share capabilities and may add a degree of freedom (DOF) between traction motor speed and vehicle speed so that greater control of the system can be achieved. Further, combining elements of both systems to create an integrated FCEV powertrain with power split capability may allow for elimination of one complete motor/inverter system, thereby potentially reducing costs.

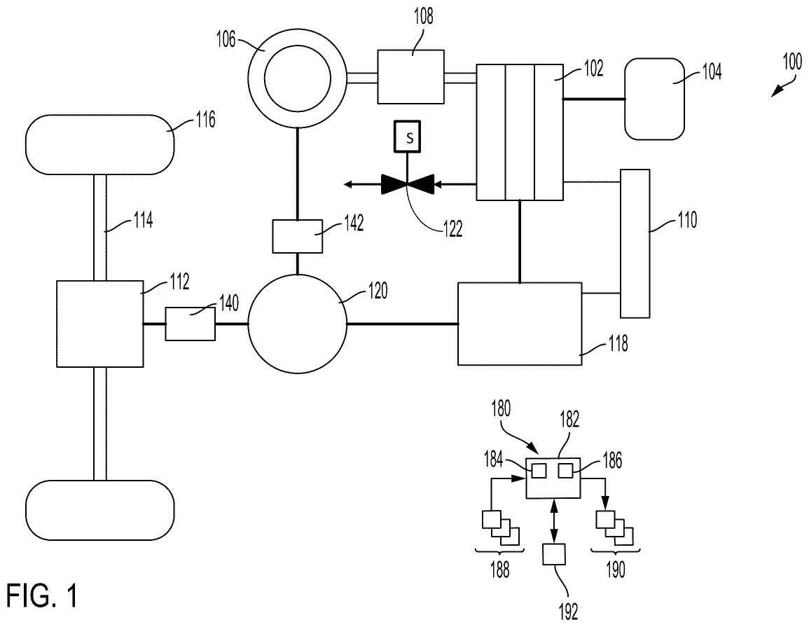

Turning to the figures, FIG. 1 shows a schematic depiction of an example fuel cell electric vehicle system 100 in accordance with the disclosure. The system 100 comprises a fuel cell or fuel cell stack 102. The fuel cell may comprise one or more electrochemical cells that convert the chemical energy of a fuel, e.g., hydrogen, and an oxidizing agent, e.g., oxygen, into electricity via redox reactions. Fuel cells may be different from most batteries in that they may use a source of fuel and oxygen (usually from air) to sustain the chemical reaction, whereas in a battery the chemical energy usually comes from substances that are already present in the battery. Fuel cells can produce electricity as long as fuel and oxygen are supplied.

As a nonlimiting example, fuel cell 102 may be a polymer electrolyte membrane (PEM) fuel cell. In a PEM fuel cell, an electrolyte membrane is sandwiched between a positive electrode (cathode) and a negative electrode (anode), so that the fuel cell 102 has multiple layers in a stack. Hydrogen is introduced to the anode, and oxygen (from air) is introduced to the cathode. The hydrogen molecules break apart into protons and electrons due to an electrochemical reaction in a fuel cell catalyst in the fuel cell. Protons then travel through the membrane to the cathode and electrons may then travel through a circuit in system 100 to perform work, such as providing power to various components in system 100, then recombine with the protons on the cathode side where the protons, electrons, and oxygen molecules combine to form water. The chemical reaction that creates energy in the fuel cell is the same as burning hydrogen with oxygen to create H₂O (water). This electrochemical method used in fuel cells is very efficient and fuel cells are much lighter than large batteries that are often used.

In order to supply hydrogen to the fuel cell 102, system 100 may include a hydrogen source 104. For example, hydrogen source 104 may comprise one or more hydrogen storage tanks that can be refilled. Another advantage of a fuel cell system to generate power is that filling up a hydrogen tank to make hydrogen available to the fuel cell may be much quicker than charging an empty battery.

The hydrogen source 104 may be fluidically coupled to fuel cell 102 to provide hydrogen to the fuel cell and the connection between the hydrogen source and the fuel cell may include various other components (not shown), such as one or more valves to control hydrogen flow, injectors to inject hydrogen into the fuel cell layers, and various other components.

In addition to the fuel cell stack and the hydrogen tanks, system 100 includes an air compressor 106 to supply air to the fuel cell 102. The compressor can be controlled to provide a target amount of air, including oxygen, at a desired pressure through layers in the fuel cell stack so that the reaction between hydrogen (H₂) and oxygen (O₂) can take place at a desired ratio in the fuel cell to generate electricity. The air compressor may be any suitable type of compressor including but not limited to: a roots, scroll, or screw compressor, which may operate at around 10-14 k rpm, or a high centrifugal compressor, which may operate at around 90-150 k rpm.

The air compressor 106 may include various components such as an air intake to capture environmental air, one or more air filters to filter the intake air and other components (not shown). The air compressor 106 may be fluidically coupled to the fuel cell to provide oxygen to the fuel cell. The connection between the compressor 106 and fuel cell 102 may include various components 108 such as air coolers, humidifiers etc. Excess air from the compressor and water may be output from the fuel cell, therefore system 100 may include one or more water separators to separate air from water output from the fuel cell. Excess air from the compressor may be controlled with a back pressure regulator valve 122. This provides a method of controller fuel cell compressor load. The water output by the fuel cell may be delivered to other system components or output to the environment and the air output by the fuel cell may be directed back into the compressor, into other components of the system, or output to the environment.

System 100 may further comprise one or more batteries to store electricity generated by the fuel cell or other system components. For example, battery 110 may be electronically coupled to fuel cell 102 and configured to receive power generated by the fuel cell. Battery 110 may be electronically coupled to various components in system 100 to provide power to the components during certain conditions. For example, battery 110 may be coupled to motor system 118 described below.

System 100 further comprises an electric motor 118 that is configured to be powered by the fuel cell 102 and/or battery 110. In some examples, motor 118 may include an inverter for controlling the speed and/or torque of the motor. The electric motor may be mechanically coupled via a power split transmission 120 to both the air compressor 106 and a traction device 112 or other device in system 100. For example, the electric motor may be mechanically coupled via a power split transmission 120 to both the air compressor 106 and a driveshaft of the vehicle. In this way, the motor 118 may be used to provide power to turn the wheels 116 of a vehicle via an axle 114 to drive the vehicle. As used herein, the term “driveshaft” is intended to mean any suitable component for transmitting mechanical power, torque, and/or rotation, usually used to connect other components of a drivetrain of a vehicle.

In system 100, motor 118 may be a single motor couple via power split transmission 120 to both the traction device 112 (e.g., driveshaft) and the compressor 106. In some examples, there may be no other electric motors included in system 100 so that motor 118 is the only electric motor in the system. However, it should be understood that in other examples additional motors may be included in system 100 to provide power to other components in the system.

As remarked above, the term “power split” is intended to mean any suitable system or component that takes a power input and outputs two or more power outputs, for example to two or more different subsystems. The term “transmission” as used herein is intended to mean any suitable system, component or medium that transmits power generated by a power source, e.g., a motor, to drive other components of a system. For example, in system 100, the power split transmission 120 may comprise a mechanical system of gears or gear trains that transmits power generated by electric motor 118 to one or more wheels or traction devices in the vehicle system in addition to transmitting power to compressor 106 via a mechanical connection between power split transmission 120 and compressor 106.

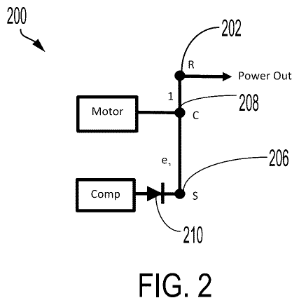

Power split transmission 120 may be any suitable transmission system or component that is powered by motor 118 via a mechanical coupling with motor 118 and that splits that power from motor 118 into two separate power paths: one path to power the compressor 106 and the other to power the traction device 112 (e.g., driveshaft). In some examples, power split transmission 120 may comprise a planetary gear set with any suitable planetary topology such as conventional, magnetic gearing, or fixed ratio traction drive gearing. Nonlimiting examples of power split transmission 120 are shown and described in more detail below with reference to FIG. 2. In some examples, system 100 may include a downstream gearbox 140 located between power split transmission 120 and traction device 112 used to control speed and/or torque output by powersplit transmission 120 to traction device 112.

System 100 may also include a control system 180 with a controller 182. The controller 182 may include a processor 184 and memory 186. The memory 186 may hold instructions stored therein that when executed by the processor cause the controller 182 to perform the various methods, control techniques, and the like, described herein. The processor 184 may include a microprocessor unit and/or other types of circuits. The memory 186 may include known data storage mediums such as random access memory, read only memory, keep alive memory, combinations thereof, and the like.

The controller 182 may receive various signals from sensors 188 positioned in different locations in the system 100. The sensors may include speed sensors, energy storage device temperature sensor(s), an energy storage device state of charge sensor(s), wheel speed sensors, and the like. The controller 182 may also send control signals to various actuators 190 coupled at different locations in the system 100. For instance, the controller 182 may send signals to an inverter in motor 118 to adjust the rotational speed of the motor. In another instance, the controller 182 may send signals to an air compressor back pressure control valve 122 contained in fuel cell system 102 to adjust load on the air compressor 106. The control of air compressor back pressure valve 122 may be closed loop with feedback sensors. In response to receiving the control commands, the other controllable components in the system may function in a similar manner with regard to command signals and actuator adjustment.

System 100 may also include one or more input device(s) 192 (e.g., an accelerator pedal, a brake pedal, a console instrument panel, a touch interface, a touch panel, a keyboard, combinations thereof, and the like). The input device(s) 192, responsive to driver input, may generate an acceleration adjustment request, for example.

FIG. 2 shows an example power split transmission configuration lever diagram. As mentioned above, power split transmission 120 may comprise a planetary gear set with any suitable planetary topology such as conventional, magnetic gearing, or fixed ratio traction drive gearing.

In some examples, the type of planetary gearing used may be selected depending on what type of air compressor is included in the fuel cell system. For example, conventional planetary gearing shown in FIG. 2 may be used for root, scroll or screw compressors that may operate at around 10-14K RPM (rotations per minute). Alternatively, for high centrifugal compressors, which operate at around 90-150K RPM, magnetic gearing or traction drive gearing may be used.

FIG. 2 shows a schematic example of a conventional planetary gear set 200. In the illustrated example, the planetary gear set 200 includes a sun gear 206 that meshes with a set of planet gears 204. The planet gears in the set of planet gears 204 are coupled to a carrier 208 such that they are able to rotate thereon. To enable the rotation between the planet gears in the set of planet gears 204 and the carrier 208, bearings (e.g., needle roller bearings) may be positioned on the carrier. These bearings may be designed to support and permit rotation of the corresponding planet gears. As such, the bearings may include races, roller elements (e.g., needle rollers, cylindrical rollers, tapered cylindrical rollers, or balls), and the like. The other bearings described herein may include similar components. The planetary gear set 200 further includes a ring gear 202 that rotates on a shaft (not shown). The ring gear 202 may include inner teeth that mesh with a set of planet gears. Though planetary gear set 200 is shown as a conventional planetary gear in FIG. 2, other planetary topologies may be used.

For example, the power split transmission configuration may comprise magnetic planetary gearing that uses Halbach arrays, which are an arrangement of magnets in a specific configuration to produce a single sided flux density. Magnetic gearing may be used when system 100 includes centrifugal style compressors for high speed and high ratio advantages.

As another example, the power split transmission configuration may comprise fixed ratio traction drive (FRTD) gearing. A fixed ratio traction drive is a form of planetary gearing with no gear teeth that uses elasto-hydrodynamic lubrication film (EHDL) or the like for torque transfer through fluid properties and high contact forces.

In order to split the input power from the single dual purpose electric input motor 118, the carrier 208 may be connected to the motor 118 to provide tractive power plus fuel cell compression power. The sun gear 206 may be connected to the fuel cell compressor. The sun gear 206 may be fitted with a one-way clutch 210 to prevent reverse rotation of the sun gear and fuel cell compressor. The one-way clutch 210 also allows for an electric vehicle mode with direct drive through the planetary gearset by providing a reaction point. The ring gear 202 is the tractive output connected to the driveshaft and/or the rest of vehicle driveline. Each gear of planetary gear set 200 may be mechanically coupled to the corresponding component in the system in various ways. For example, the sun gear 206 may be rotationally coupled (e.g., splined, bolted, welded, combinations thereof, and the like) to a rotor of compressor 106 via a shaft, for example. Likewise, the carrier 208 and the ring gear 202 may be rotationally coupled via shafts to rotors of the motor 118 and traction device 112 respectively. In order to handle speeds and loads of a vehicle system, such as system 100, the ring gear 202 to sun gear 206 ratio may be in the inclusive range 1.5 to 4.5 for conventional toothed gearing and low speed compressors or 10.0 to 20.0 for alternative planetary topologies and high-speed compressors, however other suitable ratios are contemplated. The planetary gearset ratio and kinematics may determine the torque balance through the lever used to drive the fuel cell compressor. The system may thus be constrained in the torque domain and exhibits an additional degree of freedom in the speed domain rendering the split ratio variable in the power domain. Therefore, in optimal system design the planetary gear set topology and selected ratio may be chosen with regard to both the compressor characteristics and system output requirements in the tractive domain.

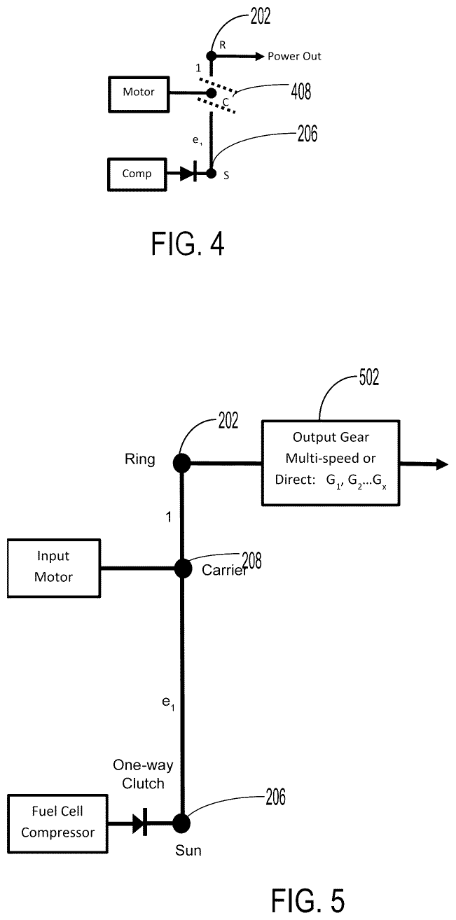

FIGS. 4 and 5 show alternative planetary gearset configurations, using the same numbering as in FIG. 2. In particular, FIG. 4 shows an example power split transmission configuration utilizing a tapered traction drive planetary having tapered cylindrical rolls 408, for example. FIG. 5 shows an example power split configuration connected to a downstream gearbox 502. Gearbox 502 may correspond to downstream gearbox 140 shown in FIG. 1 described above, Gearbox 502 may be used to control speed and/or torque output by powersplit transmission 120 to traction device 112 in some examples.

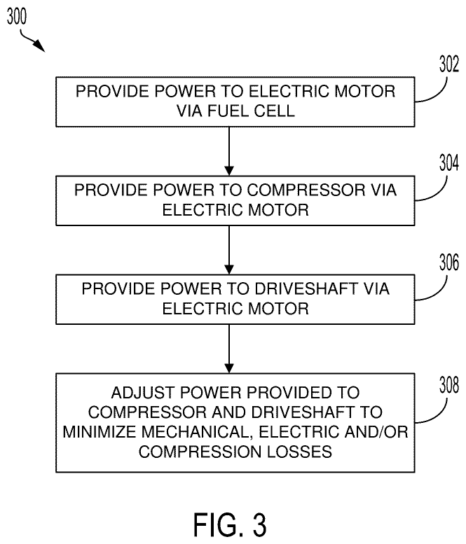

FIG. 3 shows an example method 300 of operating a fuel cell electric vehicle system, e.g., system 100 shown in FIG. 1, in accordance with the disclosure. Method 300 may be implemented to balance compressor and traction loads in the vehicle system and to optimize operation of a single motor/inverter system, such as motor 118 shown in FIG. 1, by minimizing energy consumption in the system.

At 302, method 300 comprises providing power to an electric motor via a fuel cell. For example, fuel cell 102 may supply electricity to motor 118 to power the electric motor. An inverter in the motor 118 may be used to adjust rotation speed and/or torque of the motor to achieve a target amount of power supplied to the downstream compressor 106 and traction device 112 via the power split transmission 120.

At 304, method 300 comprises providing power to an air compressor coupled to the fuel cell via the electric motor. For example, power from motor 118 may be used as input to the power split transmission 120 and a portion of that power may be mechanically transferred to compressor 106 via the power split transmission 120.

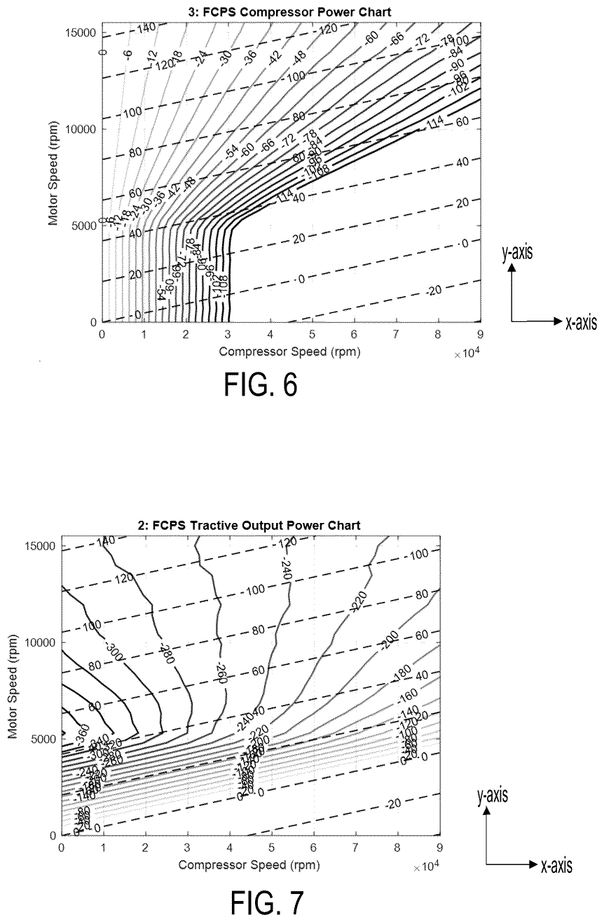

Referring to FIG. 6, this shows an example plot for compressor power, with X axis representing fuel cell compressor speed, Y axis representing input motor speed, dashed lines representing iso-lines of constant vehicle speed, and contour lines representing iso-lines of compressor power.

At 306, method 300 comprises providing power to a driveshaft of the vehicle via the electric motor. For example, a portion of the power supplied to power split transmission 120 by the motor 118 may be mechanically transferred to traction device 112, e.g., a driveshaft of the vehicle, via the power split transmission 120.

Referring to FIG. 7, this shows an example plot for tractive output power, with X axis representing fuel cell compressor speed, Y axis represents input motor speed, dashed lines representing iso-lines of constant vehicle speed, and contours representing iso-lines of tractive output power.

At 308, method 300 comprises adjusting power provided to the compressor and/or driveshaft to minimize mechanical, electric and/or compression losses in the system. For example, the power provided to the air compressor and driveshaft may be adjusted to meet a vehicle tractive power demand while minimizing mechanical, electric, and/or compression losses in the vehicle.

In some examples, operation of the system may be adjusted to minimize a compression power ratio, which may be calculated as input power consumed by the compressor 106 divided by the power supplied to the power split transmission 120 by the motor 118. Adjusting operation of the system to minimize energy consumption of the system may be implemented in a variety of ways. For example, input motor rotation speed and/or torque may be adjusted and one or more valves in the system may be used to control the amount of power transmitted from the motor to the compressor and traction device via the power split transmission. In some examples, one or more multispeed gearboxes may be included in the system to adjust operation to minimize energy consumption in the system.

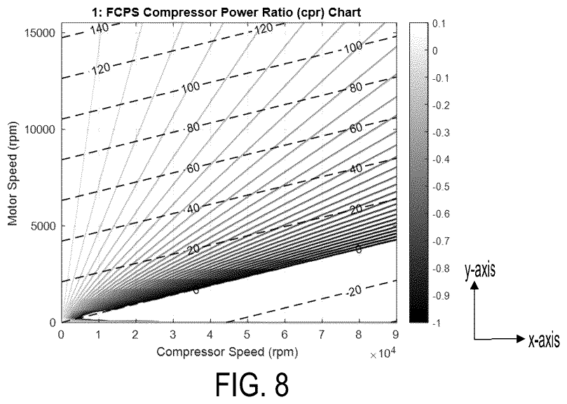

Referring to FIG. 8, this shows an example plot for compressor power ratio, with X axis representing fuel cell compressor speed, Y axis representing input motor speed, dashed lines representing iso-lines of constant vehicle speed, and contours representing iso-lines of compressor power ratio. Compressor power ratio (cpr) derivation is analogous to electrical power ratio in a power split internal combustion engine (ICE) hybrid with equation in identical form, where transmission ratio is defined as input speed divided by output speed and cpr equation given as below where e₁ represent the ring to sun ratio of the planetary gearset.

$$Trans ratio = TR = \frac{{ω}_{motor}}{{ω}_{output}} cpr = \frac{{P}_{comp}}{{P}_{motor}} = \frac{{e}_{1}}{( {e}_{1} + 1 ) * TR} - 1$$

The significance of compressor power ratio for fuel cell powershift (FCPS) operation and optimization is described next. Compressor power ratio (cpr) is fraction of input power used to drive compressor (see equations above), −1 indicates all input power consumed by compressor, cpr=0 is no compressor load, cpr<−1 indicates undesirable power recirculation, that may be reduced or substantially avoided by operating point selection). Optimization opportunity in basic form may be achieved by selection of operating points that satisfy tractive power demand while minimizing compressor power ratio (cpr→0). Optimization opportunity in advanced form may be achieved by selection of operating points that satisfy tractive power demand while minimizing total system losses (mechanical, electrical, compression). Regions on FIG. 8 cpr plot directly on the Y axis represent pure electric vehicle operation with no fuel cell output. Regions on FIG. 8 near the cpr→0 represent a battery assist mode with low fuel cell output and high tractive power output. Regions on FIG. 8 near the cpr→−1 represent a battery charge mode with high fuel cell output and low tractive output.

Additional embodiments may include a shiftable multispeed transmission downstream of the FCPS system 100 planetary gearset 120 output from ring gear 202. In such cases the input motor 118 may be used to provide an e-synchronization routine to enable gear change execution. In the general case of an electric gearbox upshift, the input motor 118 speed during synchronization may be reduced by applying negative torque with the motor functioning as a generator thus sinking power to the battery 110. In the general case of an electric gearbox downshift, the input motor 118 speed during synchronization may be increased by applying positive torque with the motor thus sourcing power from the battery 110. Typically, an inherent disadvantage in a general e-synchronization routine is that faster shifts may use significant power source or sink from the battery 110, aggravated by systems with large high inertia motors.

In the specific case of a shift execution event for the FCPS system 100, the shift may be an unassisted shift with the fuel cell compressor 106 output at minimum and allowing the compressor to hold against the one-way clutch 210 at zero speed. In this case the e-synchronization routine runs with input motor 118 in speed control to a calculated synch speed target to facilitate the target speed required for ring gear 202 to match correct input speed to downstream gearbox 122 based on required gear ratio change underway. An unassisted shift requires an input condition check such that the target synch speed is achievable for a given road speed, ratio change, and respecting the added constraint that compressor speed is zero. In an unassisted shift the input motor 118 is sinking or sourcing power from the battery 110 as in the general case above.

Alternatively, a shift execution event may be an assisted shift with fuel cell compressor 106 load and fuel cell 102 power output controlled during the e-synchronization. For the assisted shift the input motor 118 is in speed control mode and the fuel cell compressor 106 is in load control mode utilizing back pressure regulator valve 122 Thus, the fuel cell 102 may continue to output power during the shift execution. This may be advantageous during a downshift were the battery 110 and fuel cell 102 are functioning as a power source. An unassisted shift also removes the constraint that fuel cell compressor 106 speed be zero during the shift execution event.

Additional embodiments may include magnetic planetary gearing 200 with a control coil to enable variable ratio magnetic powersplit gearing with a low ratio of 10:1 for example, and a high ratio of 20:1 for example. A powersplit ratio shift from low to high alters the powersplit distribution within a specific vehicle speed range, whereas a downstream gearbox 502 ratio change alters the power distribution across a different vehicle speed range. System optimization opportunity thus represents the selection of combinations of powersplit ratio and total gearbox ratios that satisfy tractive power demand and minimize system losses.

The invention will be further described in the following paragraphs. In one aspect, a system is provided that comprises a fuel cell; a compressor; and an electric motor operationally coupled via a power split transmission to a driveshaft and the compressor.

In any of the aspects or combinations of the aspects, the power split transmission may comprise planetary gearing.

In any of the aspects or combinations of the aspects, the planetary gearing may comprise magnetic gearing.

In any of the aspects or combinations of the aspects, the planetary gearing may comprise fixed ratio traction drive gearing.

In any of the aspects or combinations of the aspects, the planetary gearing may comprise a sun gear, a carrier coupled to planet gears, and a ring gear.

In any of the aspects or combinations of the aspects, the electric motor may be coupled to the carrier, the compressor may be coupled to the sun gear, and the driveshaft may be coupled to the ring gear.

In any of the aspects or combinations of the aspects, the ring gear to sun gear ratio may be in the inclusive range 10.0 to 20.0.

In any of the aspects or combinations of the aspects, the fuel cell may be configured to provide power to the electric motor and the compressor.

In another aspect, a vehicle system is provided that comprises a fuel cell stack; an electric air compressor configured to pump air through layers of the fuel cell stack; and an electric motor coupled via a planetary gearset to a driveshaft and the air compressor and configured to provide power to both the driveshaft and the air compressor.

In any of the aspects or combinations of the aspects, the planetary gearset may comprise a sun gear, a carrier coupled to planet gears, and a ring gear; and wherein the electric motor is coupled to the carrier, the air compressor is coupled to the sun gear, and the driveshaft is coupled to the ring gear.

In any of the aspects or combinations of the aspects, the compressor may be a centrifugal compressor and the planetary gearset comprises magnetic gearing.

In any of the aspects or combinations of the aspects, the compressor may be a centrifugal compressor and the planetary gearset comprises fixed ratio traction drive gearing.

In any of the aspects or combinations of the aspects, the fuel cell stack may be configured to provide power to both the electric air compressor and the electric motor.

In any of the aspects or combinations of the aspects, the vehicle system may further comprise a hydrogen source for providing hydrogen to the fuel cell stack.

In any of the aspects or combinations of the aspects, the driveshaft may be configured to drive one or more wheels.

In another aspect, a method for operating a fuel cell electric vehicle ir provided and comprises providing power to an electric motor via a fuel cell; providing power to an air compressor coupled to the fuel cell via the electric motor; and providing power to a driveshaft of the vehicle via the electric motor.

In any of the aspects or combinations of the aspects, the electric motor may be configured to provide power to both the air compressor and the driveshaft via a planetary gearset.

In any of the aspects or combinations of the aspects, the planetary gearset may comprise a sun gear, a carrier coupled to planet gears, and a ring gear; and wherein the electric motor is coupled to the carrier, the air compressor is coupled to the sun gear, and the driveshaft is coupled to the ring gear.

In any of the aspects or combinations of the aspects, power provided to the air compressor and driveshaft may meet a vehicle power demand and minimize a compressor power ratio.

In any of the aspects or combinations of the aspects, power provided to the air compressor and driveshaft may meet a vehicle tractive power demand and minimize mechanical, electric, and/or compression losses in the vehicle.

Note that the example control and estimation routines included herein can be used with various powertrain, transmission, and/or vehicle system configurations. The control methods and routines disclosed herein may be stored as executable instructions in non-transitory memory and may be carried out by the control system including the controller in combination with the various sensors, actuators, and other vehicle hardware. Further, portions of the methods may be physical actions taken in the real world to change a state of a device. The specific routines described herein may represent one or more of multiple processing strategies. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the vehicle control system, where the described actions are carried out by executing the instructions in a system including the various hardware components in combination with the electronic controller. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a fuel cell;
a compressor; and
an electric motor operationally coupled via a power split transmission to a driveshaft and the compressor.

2. The system of claim 1, wherein the power split transmission comprises planetary gearing.

3. The system of claim 2, wherein the planetary gearing comprises magnetic gearing.

4. The system of claim 2, wherein the planetary gearing comprises fixed ratio traction drive gearing.

5. The system of claim 2, wherein the planetary gearing comprises a sun gear, a carrier coupled to planet gears, and a ring gear.

6. The system of claim 5, wherein the electric motor is coupled to the carrier, the compressor is coupled to the sun gear, and the driveshaft is coupled to the ring gear.

7. The system of claim 5, wherein the ring gear to sun gear ratio is in the inclusive range 10.0 to 20.0.

8. The system of claim 1, wherein the fuel cell is configured to provide power to the electric motor and the compressor.

9. A vehicle system, comprising:
a fuel cell stack;
an electric air compressor configured to pump air through layers of the fuel cell stack; and
an electric motor coupled via a planetary gearset to a driveshaft and the air compressor and configured to provide power to both the driveshaft and the air compressor.

10. The vehicle system of claim 9, wherein the planetary gearset comprises a sun gear, a carrier coupled to planet gears, and a ring gear; and wherein the electric motor is coupled to the carrier, the air compressor is coupled to the sun gear, and the driveshaft is coupled to the ring gear.

11. The vehicle system of claim 9, wherein the compressor is a centrifugal compressor and the planetary gearset comprises magnetic gearing.

12. The vehicle system of claim 9, wherein the compressor is a centrifugal compressor and the planetary gearset comprises fixed ratio traction drive gearing.

13. The vehicle system of claim 9, wherein the fuel cell stack is configured to provide power to both the electric air compressor and the electric motor.

14. The vehicle system of claim 9, further comprising a hydrogen source for providing hydrogen to the fuel cell stack.

15. The vehicle system of claim 9, wherein the driveshaft is configured to drive one or more wheels.

16. A method for operating a fuel cell electric vehicle comprising:
providing power to an electric motor via a fuel cell;
providing power to an air compressor coupled to the fuel cell via the electric motor; and
providing power to a driveshaft of the vehicle via the electric motor.

17. The method of claim 16, wherein the electric motor is configured to provide power to both the air compressor and the driveshaft via a planetary gearset.

18. The method of claim 17, wherein the planetary gearset comprises a sun gear, a carrier coupled to planet gears, and a ring gear; and wherein the electric motor is coupled to the carrier, the air compressor is coupled to the sun gear, and the driveshaft is coupled to the ring gear.

19. The method of claim 16, wherein power provided to the air compressor and driveshaft meets a vehicle power demand and minimizes a compressor power ratio.

20. The method of claim 16, wherein power provided to the air compressor and driveshaft meets a vehicle tractive power demand and minimizes mechanical, electric, and/or compression losses in the vehicle.
